(19) United States
(12) Patent Application Publication
(10) Pub. No.: US 2002/0134597 A1
(43) Pub. Date: Sep. 26, 2002

(54) Electrical individual wheel drive

(76) Inventors: Egon Mann, Friedrichshafen (DE); Christian Stammberger, Gotha (DE); Frank Stubner, Friedrichroda (DE); Peter Streipardt, Waltershausen (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/059,526

(22) Filed: Jan. 30, 2002

(30) Foreign Application Priority Data
Jan. 16, 2001 (DE) 101 01 669.7

(51) Int. Cl. B60K 1/00

(52) U.S. Cl. 180/65.5; 180/65.6

(57) ABSTRACT

An electrical individual wheel drive has one electric motor (2) the output shaft of which is connected with an inner central gear (3) of a transmission (4) to form one piece. The ring gear (5) of the transmission is non-turnably held and the planet carrier (9) forms the output. The output shaft (1) of the electric motor (2) is supported via a bearing (7)in the housing of the electric motor (2), on one side, and side via bearings (8) of the planet carrier (9), on the other.

The invention relates to an electrical individual wheel drive of the kind defined in more detail in the preamble of claim 1.

Electrical individual wheel drives are often used in mobile vehicles such as golf carts. In such applications certain special requirements are placed on compact design and light weight.

EP 0 525 663 B1 discloses an electrical individual wheel drive where the electric motor is connected via a guide rod with the vehicle chassis and where the output shaft of the electric motor is integral with an inner central gear of a planetary set, the ring gear of which constitutes the output and the planets of which are supported on a stationarily held planet carrier. Since the output shaft of the electric motor is rigidly supported by two bearings, but the inner central gear of the planet step is integrally connected with the output shaft, the output shaft has to be elastic enough for the inner central gear to be able to adjust itself. However, the required cross-sectional reduction of the output shaft acts negatively upon the output torque.

The problem on which this invention is based is to provide an electrical individual wheel drive which is very compactly constructed and stands out by a light weight.

The problem is solved with an electrical individual drive according to the preamble of the main claim and having the characteristic features thereof.

According to the invention the electrical individual wheel drive has an electric motor preferably designed as asynchronous motor in order to reach very high rotational speed ratios of up to 6,500 r/min, for example. The output shaft of the electric motor is connected to form one piece with an inner central gear of a planetary set and it preferably has an helical cut design. At least one planetary gear is supported on a planet carrier which constitutes the output. The transmission is preferably designed with three planets. The ring gear of the motor housing, on one end, and by the planet carrier, on the other end. The planet carrier is supported in the housing of the electric motor via wheel bearings which absorb the wheel forces. The housing of the electric motor is connected with the vehicle chassis via guide rods. The transmission is adjacent to the electric motor, on one side, and to the wheel bearings on the other. A dividing wall is situated between the transmission and the electric motor with a sealing element which impermeably seals relative to the electric motor the space where the transmission is located. In the area of the wheel bearings, a brake is situated which is preferably designed as a drum brake, but can also be designed as a disk brake. The wheel bearings are preferably designed over two taper roller bearings, the inner rings being spaced apart via a spacer sleeve and the output flange is held upon the planet carrier via tapered shrink fit. In order to obtain a sufficiently low level of noise at high rotational speeds of the electric motor, the transmission is preferably helical cut and a coordination of the number of teeth is designed so as to obtain an odd ordinal number. The toothing of the transmission is preferably laid out so that there is a simultaneous engagement sequence between the inner central gear and the planetary gears.

With the output shaft of the electric motor being supported in the planet carrier, an optimal tooth engagement is obtained for the transmission. By the planet carrier constituting the output and the ring gear being stationarily held, the highest possible ratio of the transmission is achieved. By virtue of the arrangement of the transmission adjacent to the electric motor within the electric motor housing, a very compact unit is obtained. By the arrangement of a bearing of the output shaft of the electric motor within the transmission, said bearing is sufficiently supplied with lubricant in the transmission. Thus, only one more bearing with an expensive life lubrication has to be used. By the wheel bearings being disposed adjacent to the transmission, it is possible optimally to introduce the wheel force in the wheel bearings. By disposing the transmission in the electric motor housing, the weight of the electrical individual drive can be reduced. in the wheel bearings. By disposing the transmission in the electric motor housing, the weight of the electrical individual drive can be reduced.

Other advantages result from the description of the figures that follows. The drawing shows:

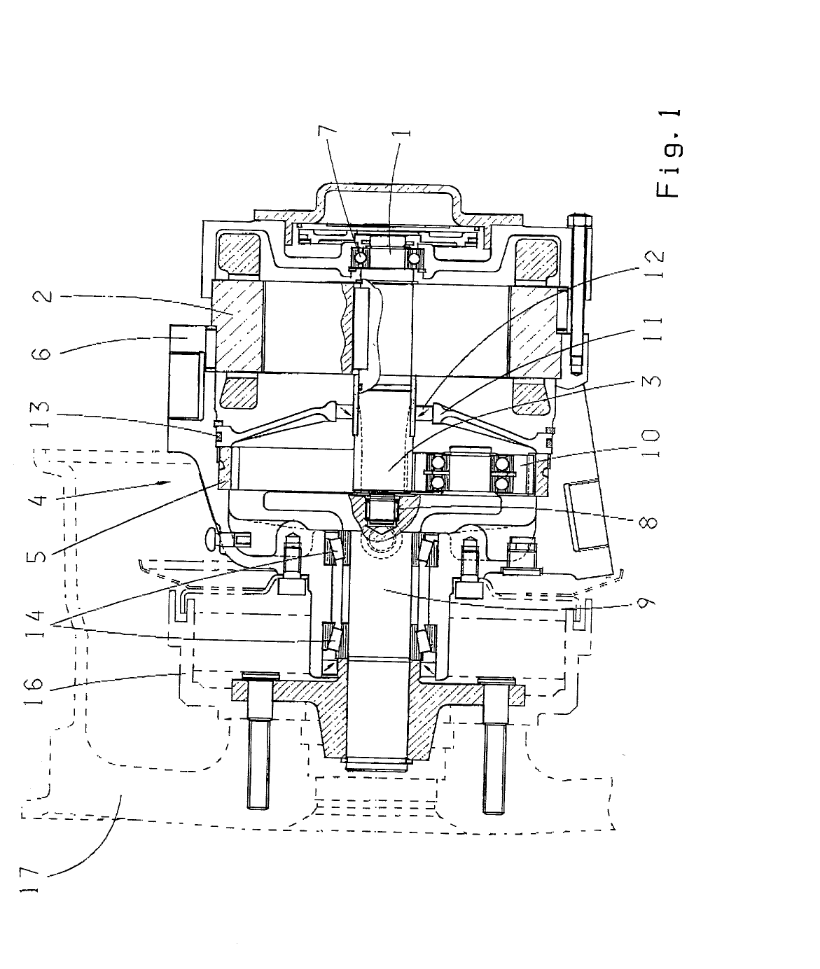

FIG. 1 is an electrical wheel drive with a rim; and

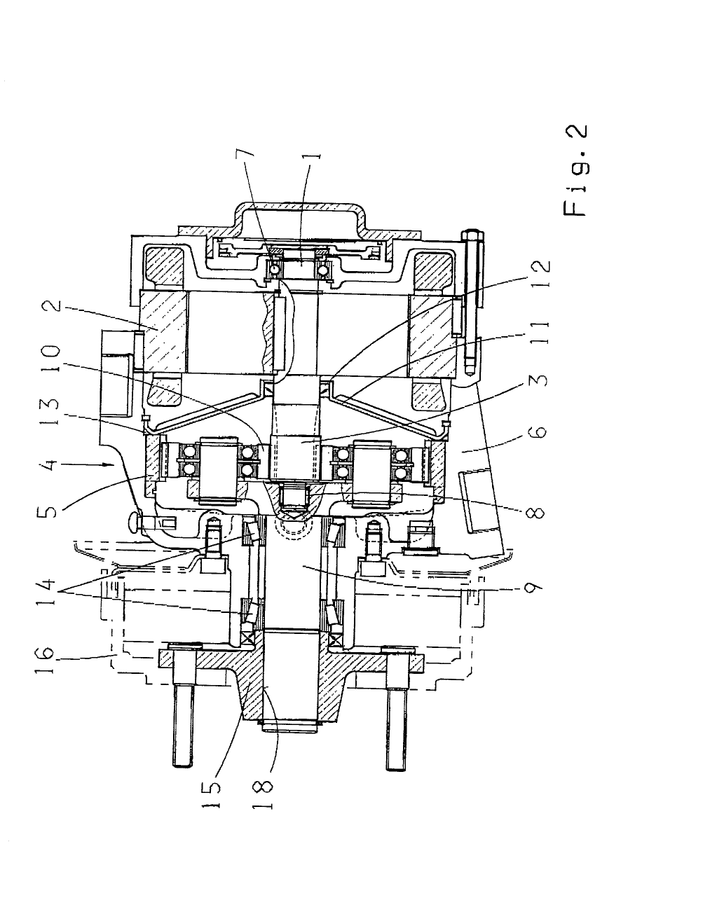

FIG. 2 is another embodiment of an electrical wheel drive.

An output shaft 1 of an electric motor 2 is connected with an inner central gear 3 of a transmission 4 to form one piece. The transmission 4 has a stationarily held ring gear 5 which is cut into the housing 6 of the electric motor 2 via a self-tapping toothing. The output shaft 1 is supported via first bearing 7, on one side, and via a second bearing 8, on the other. The second bearing 8 is supported on the planet carrier 9 upon which are also supported the planetary gears 10 and which constitutes the output. A dividing wall 11 is situated between the transmission 4 and the electric motor 2 which impermeably seals the transmission relative to the electric motor 2 via a sealing element 12 and a sealing element 3. The planet carrier 8 is supported by bearings 14 in the housing 6 of the electric motor 2. An output flange 15 is connected with the planet carrier 9 which is connected with a brake 16 and a rim 17. The bearings 14 can be disposed so that it be possible for the wheel force to be optimally absorbed.

FIG. 2:

One electric motor 2 has an output shaft 1 which is connected to form one piece with an inner central gear 3 and drives the transmission 4. The ring gear 5 of the transmission 4 is floatingly non-turnably held in a claw trapezoid toothing in the housing 6, said claw trapezoid toothing being integrally cast in the housing 6 of the electric motor 2. The housing 6 of the electric motor 2 is preferably made of cast aluminum. The output flange 15 is held on the planet carrier 10 by a tapered shrink fit 18.

Reference numerals

| | |
|---|---|
| 1 output shaft | 10 planetary gears |
| 2 electric motor | 11 dividing wall |
| 3 inner central gear | 12 sealing element |
| 4 transmission | 13 sealing element |
| 5 ring gear | 14 wheel bearings |
| 6 housing | 15 output flange |
| 7 first bearing | 16 brake |
| 8 second bearing | 17 rim |
| 9 planet carrier | 18 tapered shrink fit |

1. Electrical individual wheel drive in which one output shaft (1) of an electric motor (2) is connected to form one piece with an inner central gear (3) of a transmission (4), with at least one planetary gear (10) and one ring gear (5) and one planet carrier (9) wherein said output shaft (1) of said electric motor is supported via two bearings (7, 8), characterized in that said planet carrier (9) constitutes the output and is supported via wheel bearings (14) and said ring gear (5) is non-turnably held and first bearings (7) of said output shaft of said electric motor (2) are situated in the end area of said output shaft (1) which is placed opposite to said transmission (4) and said output shaft (1) is supported in said electric motor (2) and second bearings (8) support said output shaft (1) in said planet carrier (9).

2. Electric individual wheel drive according to claim 1, characterized in that between said transmission (4) and said electric motor (2) is situated a dividing wall (11) with one sealing element (12) which impermeably separates said transmission (4) from said electric motor (2).

3. Electric individual wheel drive according to claim 1, characterized in that said transmission (4) is situated within a housing (6) of said electric motor (2).

4. Electric individual wheel drive according to claim 1, characterized in that said wheel bearings (14) are situated adjacent to said transmission (4) and said transmission (4) adjacent to said electric motor (2).

5. Electric individual wheel drive according to claim 1, characterized in that said housing (6) of said electric motor (2) is connected via guide rods with a chassis.

6. Electric individual wheel drive according to claim 1, characterized in that said planet carrier (9) is supported via said bearings (14) in a housing (6) of said electric motor.

7. Electric individual wheel drive according to claim 1, characterized in that a brake (16) is situated in the area of said bearings (14).

8. Electric individual wheel drive according to claim 1, characterized in that said electric motor (2) is an asynchronous motor.

9. Electric individual wheel drive according to claim 1, characterized in that said transmission (4) is helical cut and said inner central gear (3) and said planetary gears (10) have a simultaneous engagement sequence.

10. Electric individual wheel drive according to claim 1, characterized in that the number of teeth of said transmission (4) has an odd ordinal number.
